(19) United States
(12) Patent Application Publication
(10) Pub. No.: US 2026/0176084 A1
(43) Pub. Date: Jun. 25, 2026

(54) CONVEYOR SYSTEM WITH TIP PREVENTION

(71) Applicant: Laitram, L.L.C., Harahan, LA (US)

(72) Inventor: Bryant G. Ragan, Metairie, LA (US)

(21) Appl. No.: 19/125,508

(22) PCT Filed: Oct. 24, 2023
(86) PCT No.: PCT/US2023/077612

§ 371 Date: Apr. 29, 2025

Related U.S. Application Data
(60) Provisional application No. 63/425,070, filed on Nov. 14, 2022.

(51) Int. Cl. B65G 47/24; B65G 17/46; B65G 47/26; B65G 47/52

(52) U.S. Cl. CPC B65G 47/24; B65G 17/46; B65G 47/261; B65G 47/52

(57) ABSTRACT

A conveyor system for conveying lightweight electrically conductive containers, such as empty aluminum cans. Magnetic fields to prevent the cans from tipping over as they are conveyed on a conveying surface. Coil sets on opposite sides of the conveying surface produce the magnetic fields in response to tip-sensor detections of tipping cans. The magnetic fields interact with the electrically conductive cans to right them.

### BACKGROUND

The invention relates generally to power-driven conveyors and more particularly to conveyors that use magnetics to prevent conveyed containers from tipping over.

The beverage industry uses aluminum cans and bottles as beverage containers. The containers are accelerated in a single file to a high-speed for presentation to a processing step such as can or bottle decoration. Because aluminum cans and bottles are thin and light, windage at high conveying speeds tends to tip empty cans or bottles rearward. If the windage and conveying speeds are great enough, the cans or bottles can tip completely over and can't be properly processed.

### SUMMARY

One version of a conveyor system embodying features of the invention comprises a conveyor having a conveying surface that extends in width from a left side to a right side and in length from an entrance end to an exit end. The conveyor is suitable for conveying electrically conductive containers atop the conveying surface in a conveying direction. A series of right-side coil sets extends along the length of the conveyor on the right side, and a series of left-side coil sets extends along the length of the conveyor on the left side. A controller selectively sends drive signals to the left- and right-side coil sets to adjust the magnitudes of magnetic fields between the left and right sides produced by the left- and right-side coil sets. A series of tip sensors is spaced apart along the length of the conveyor at sensor positions to detect tipped electrically conductive containers passing the sensor positions and sends sensor signals to the controller indicating tipped electrically conductive containers. The controller sends drive signals to the left- and right-side coil sets in the vicinity of the tip sensors that indicate a tipped electrically conductive container to produce magnetic fields between the left and right sides that induce forces acting to untip the tipped electrically conductive containers.

A version of a conveyor system for conveying electrically conductive containers having tops and bottoms and centers of mass comprises a conveyor having a conveying surface that extends in width from a left side to a right side and in length from an entrance end to an exit end. The conveyor is suitable for conveying electrically conductive containers atop the conveying surface in a conveying direction. A series of right-side coil sets extends along the length of the conveyor on the right side and produces a magnetic field with a maximum field strength above the conveying surface at a maximum-field-strength level. A series of left-side coil sets extends along the length of the conveyor on the left side and produces a magnetic field with a maximum field strength above the conveying surface at the maximum-field-strength level. The left- and right-side coil sets are configured so that the maximum-field-strength level is above the centers of mass of the electrically conductive containers or is closer to the top than to the bottom of the electrically conductive containers to interact with fields induced in the electrically conductive containers to produce a force acting in the conveying direction on the electrically conductive containers above their centers of mass.

### BRIEF DESCRIPTION OF THE DRAWINGS

FIG. 1 is a partly cut-away isometric view of one version of a tip-preventing conveyor system for electrically conductive containers.

FIG. 2 is another view as in FIG. 1 with left- and right-side coil sets revealed.

FIG. 3 is a front elevation view of the conveyor system of FIG. 1.

FIG. 4 is a partly cut-away isometric view of another version of a tip-preventing conveyor system.

FIG. 5 is a block diagram of a control system for the conveyor systems of FIGS. 1 and 4.

FIGS. 6A-6D are sequential side views of the conveyor system of FIG. 1 conveying a tipping can with the left-side rail removed for clarity.

FIG. 7 is a plot of upper and lower sensor signals corresponding to the sequence shown in FIGS. 6A-6D.

### DETAILED DESCRIPTION

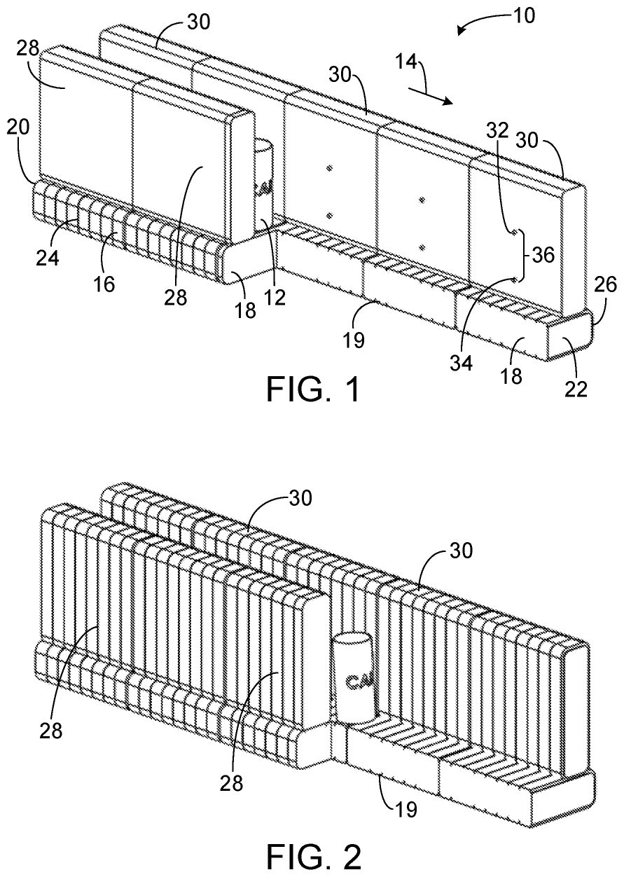

One version of a conveyor system for accelerating electrically conductive containers is shown in FIG. 1. The conveyor system 10 conveys electrically conductive containers 12, such as aluminum cans or bottles, in a single file in a conveying direction 14. For simplicity, cans 12 will be used throughout the description as an exemplary electrically conductive container. An electromagnetic conveyor 16 is constructed of a series of coils 18 that form a linear-motor stator 19. The stator 19 produces an electromagnetic field that induces currents in the passing electrically conductive cans 12. The induced currents generate a magnetic field that interacts with the stator field to produce a force that propels the cans 12 in the conveying direction 14. The coils 18 are topped by a cover (not shown) that provides a continuous conveying surface to the cans 12. The cover can be the top of a protective housing or the top surface of potting material encapsulating the stator coils 18. The conveying surface over the stator coils 18 extends in length in the conveying direction 14 from an entrance end 20 to an exit end 22 and in width from a left side 24 to a right side 26.

A series of left-side and right-side coil sets 28, 30 extend along the length of the conveyor 16 at the left and right sides 24, 26. The coil sets 28, 30 form side rails that stand up above the conveying surface of the conveyor 16. The coil sets 28, 30 are close together across the width of the conveyor 16 for good magnetic coupling to the cans 12. As FIG. 1 shows, the coil sets 28, 30 are potted or enclosed in protective housings. FIG. 2 shows the coil sets 28, 30 with the housing or potting removed. FIG. 1 also shows upper and lower sensors 32, 34 in pairs that together form a tip sensor 36 that can detect tipped cans. The upper and lower sensors 32, 34 are aligned perpendicular to the conveying surface with the lower sensor closer to the conveying surface. The tip sensors 36 are spaced apart along the length of the conveyor 16 at sensor positions. In this example, each of the tip sensors 36 is associated with one of the right-side coil sets 30. Similar sensors or complementary components of the upper and lower sensors 32, 34 on the right-side coil sets 30 could be similarly arranged on the left-side coil sets 28. The tip sensors may be proximity sensors, metal detectors, ultrasonic sensors, optical sensors, or any sensor capable of detecting the presence of a can at the sensor position.

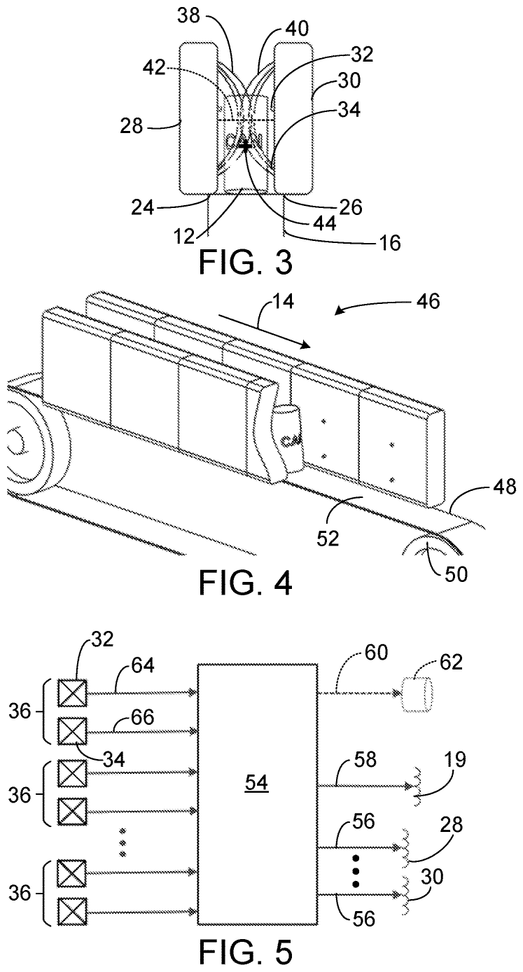

As shown in FIG. 3, the left- and right-side coil sets 28, 30 produce magnetic fields 38, 40 between the left and right sides 24, 26 of the conveyor 16. The net field strength is strongest at a maximum-field-strength level 42 above the center of mass 44 of the can 12. Typically, for an aluminum can, the maximum-field-strength level 42 would be closer to the top of the can 12 than to its bottom. The upper sensor 32 is sensitive to an upper portion of the passing cans 12, and the lower sensor 34 is sensitive to a lower portion of the can.

Another version of a conveyor system is shown in FIG. 4. The conveyor system 46 differs from the conveyor system 10 of FIG. 1 only in that the conveyor is a conveyor belt 48 driven in the conveying direction 14 by motor-driven sprockets or pulleys 50. The outer surface 52 of the conveyor belt 48 forms the conveyor's conveying surface.

The stator 19 and the left- and right-side coil sets 28, 30 of FIG. 1 are controlled by a controller 54 as shown in FIG. 5. The controller 54 includes a programmable processor, such as a programmable logic controller or a desktop or laptop computer, and coil drivers. The controller 54, executing program steps in a program memory, selectively sends drive signals 56 to the left- and right-side coil sets 28, 30. The controller 54 also sends stator drive signals 58 to the stator 19 to control the speed of the cans along the conveyor. If the conveyor is the conveyor belt 48 of FIG. 4, the controller 54 instead sends motor-control signals 60 to drive the belt's motor 62. Sensor signals 64, 66 from the upper and lower sensors 32, 34 of each tip sensor 36 are sent to the controller 54. The controller 54 compares the upper sensor signal 64 to the lower sensor signal 66 to determine if a can is tipping rearward and, via the drive signals 56, increases the power to the coil sets 28, 30 in the vicinity of the tip sensor 36 to untip the can.

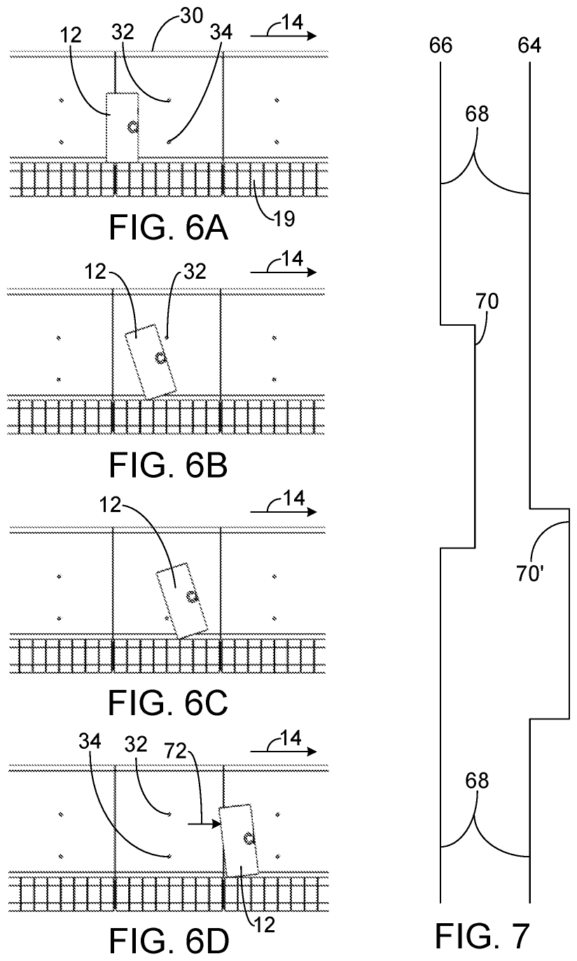

FIGS. 6A-6D show a sequence of a can 12 starting to tip rearward and then righted by the left- and right-side coil set. In FIG. 6A an upright empty can 12 is propelled in the conveying direction 14 by the stator 19. Because the can 12 has not yet reached the position of the sensors 32, 34 of the middle coil set 30, the upper- and lower-sensor detect signals 64, 66 shown in FIG. 7 are both in the same no-detect state 68. While the can 12 is accelerated along the stator 19, windage causes the can 12 to start tipping rearward as shown in FIG. 6B. The bottom portion of the tipping can 12 is first detected as present at the lower-sensor position. When that happens, the lower sensor 34 changes the state of the lower-sensor detect signal 66 to a detect state 70. Because the rearwardly tipped can 12 has not yet been detected by the upper sensor 32, its detect signal remains in the no-detect state 68. As the tipping can 12 continues to advance in the conveying direction 14, the upper portion of the can is detected at the upper-sensor position by the upper sensor 32, which changes the state of the upper-sensor detect signal 64 to the detect state 70′. The controller, which continuously compares the upper-sensor detect signals 64 to the lower-sensor detect signals 66, recognizes that the change of state 70 of the lower-sensor detect signal preceded the change of state 70′ of the upper-sensor detect signal indicating a tipping can 12. So the controller sends drive signals to the left- and right-side coil sets to increase their power. The resulting greater magnetic fields induce greater currents in the can 12 that produce a resulting magnetic field that interacts with the fields of the coil sets to apply a righting force 72 in the conveying direction 14 to the upper portion of the can 12 above its center of mass, as shown in FIG. 6D. In the meantime, the can 12 has cleared the positions of the upper and lower sensors 32, 34 so that their detect signals 64, 66 are returned to the no-detect state 68.

As previously described, the power to the left- and right-side coil sets is increased whenever a tipping can is detected. When a can is not detected, the left- and right-side coil sets can be unpowered to produce no magnetic fields, or they can be powered at a constant low-power level to repel the cans away from contact with the side rails. In that way the left- and right-side coil sets provide a touchless side rail that prevents the sides of the single-filed cans from being scratched or otherwise marred.

1. A conveyor system comprising:
a conveyor having a conveying surface that extends in width from a left side to a right side and in length from an entrance end to an exit end and is suitable for conveying electrically conductive containers atop the conveying surface in a conveying direction;
a series of right-side coil sets extending along the length of the conveyor on the right side;
a series of left-side coil sets extending along the length of the conveyor on the left side;
a controller selectively sending drive signals to the left- and right-side coil sets to adjust the magnitudes of magnetic fields between the left and right sides produced by the left- and right-side coil sets;
a series of tip sensors spaced apart along the length of the conveyor at sensor positions to detect tipped electrically conductive containers passing the sensor positions and send sensor signals to the controller indicating tipped electrically conductive containers;
wherein the controller sends drive signals to the left- and right-side coil sets in the vicinity of the tip sensors that indicate a tipped electrically conductive container to produce magnetic fields between the left and right sides that induce forces acting to untip the tipped electrically conductive containers.

2. The conveyor system as claimed in claim 1 wherein the conveying surface is the outer surface of a conveyor belt driven in the conveying direction and carrying the electrically conductive containers.

3. The conveyor system as claimed in claim 1 wherein the conveying surface is a cover over a series of coils forming a linear-motor stator that produces an electromagnetic field that propels the electrically conductive containers atop the conveying surface in the conveying direction.

4. The conveyor system as claimed in claim 1 wherein the left- and right-side coil sets are arranged to produce magnetic fields that are strongest above the center of mass of the electrically conductive containers.

5. The conveyor system as claimed in claim 1 wherein the left- and right-side coil sets are constantly driven at a low-power level and wherein the controller selectively increases the power level to individual left- and right-side coil sets to untip passing electrically conductive containers.

6. The conveyor system as claimed in claim 1 wherein the upper and lower sensors are selected from the group consisting of proximity sensors, metal detectors, ultrasonic sensors, and optical sensors.

7. The conveyor system as claimed in claim 1 wherein each of the tip sensors includes a lower sensor at a lower-sensor position and an upper sensor at an upper-sensor position farther above the level of the conveying surface than is the lower-sensor position.

8. The conveyor system as claimed in claim 7 wherein the lower sensor and the upper sensor are aligned perpendicular to the conveying surface.

9. The conveyor system as claimed in claim 7 wherein the lower sensor detects the presence of an electrically conductive container passing the lower-sensor position and sends a lower-sensor detect signal to the controller indicating the presence of the electrically conductive container and wherein the upper sensor detects the presence of the electrically conductive container passing the upper-sensor position and sends an upper-sensor detect signal to the controller indicating the presence of the electrically conductive container.

10. The conveyor system as claimed in claim 1 wherein the electrically conductive containers are empty beverage cans or bottles made of aluminum.

11. A conveyor system for conveying electrically conductive containers having tops and bottoms and centers of mass, the conveyor system comprising:
a conveyor having a conveying surface that extends in width from a left side to a right side and in length from an entrance end to an exit end and is suitable for conveying electrically conductive containers atop the conveying surface in a conveying direction;
a series of right-side coil sets extending along the length of the conveyor on the right side and producing a magnetic field having a maximum field strength above the conveying surface at a maximum-field-strength level;
a series of left-side coil sets extending along the length of the conveyor on the left side and producing a magnetic field having a maximum field strength above the conveying surface at the maximum-field-strength level;
wherein the left- and right-side coil sets are configured so that the maximum-field-strength level is above the centers of mass of the electrically conductive containers or is closer to the top than to the bottom of the electrically conductive containers to interact with fields induced in the electrically conductive containers to produce a force acting in the conveying direction on the electrically conductive containers above their centers of mass.

12. The conveyor system as claimed in claim 11 comprising a series of tip sensors spaced apart along the length of the conveyor at sensor positions to detect tipped electrically conductive containers passing the sensor positions.

13. The conveyor system as claimed in claim 12 wherein each of the tip sensors includes a lower sensor at a lower-sensor position and an upper sensor at an upper-sensor position farther above the level of the conveying surface than is the lower-sensor position.

14. The conveyor system as claimed in claim 12 wherein each of the tip sensors includes a lower sensor at a lower-sensor position below the center of mass of the electrically conductive container and an upper sensor at an upper-sensor position above the center of mass of the electrically conductive container.

15. The conveyor system as claimed in claim 12 comprising a controller and wherein the tip sensors send sensor signals to the controller indicating tipped electrically conductive containers and wherein the controller sends drive signals to the left- and right-side coil sets to adjust the magnitudes of magnetic fields between the left and right sides produced by the left- and right-side coil sets to untip tipped electrically conductive containers.

16. The conveyor system as claimed in claim 12 wherein each of the tip sensors includes a lower sensor at a lower-sensor position and an upper sensor at an upper-sensor position farther above the level of the conveying surface than is the lower-sensor position.

17. The conveyor system as claimed in claim 16 wherein the lower sensor and the upper sensor are aligned perpendicular to the conveying surface.

18. The conveyor system as claimed in claim 16 wherein the lower sensor detects the presence of an electrically conductive container passing the lower-sensor position and sends a lower-sensor detect signal to the controller indicating the presence of the electrically conductive container and wherein the upper sensor detects the presence of the electrically conductive container passing the upper-sensor position and sends an upper-sensor detect signal to the controller indicating the presence of the electrically conductive container.

19. The conveyor system as claimed in claim 11 comprising a controller selectively sending drive signals to the left- and right-side coil sets to adjust the magnitudes of magnetic fields between the left and right sides produced by the left- and right-side coil sets.

20. The conveyor system as claimed in claim 11 wherein the electrically conductive containers are empty beverage cans or bottles made of aluminum.
